(19) United States
(12) Patent Application Publication
(10) Pub. No.: US 2020/0120397 A1
(43) Pub. Date: Apr. 16, 2020

(54) METHOD FOR PROVIDING REMINDERS BASED ON VIEWING HISTORY INFORMATION

(71) Applicant: ARRIS Enterprises LLC, Suwanee, GA (US)

(72) Inventors: Libo Sheng, Shanghai (CN); Fenggen Hu, Shanghai (CN)

(21) Appl. No.: 15/736,335

(22) PCT Filed: Jul. 7, 2017
(86) PCT No.: PCT/CN2017/092267

§ 371 Date: Dec. 14, 2017

(51) Int. Cl. H04N 21/488; H04N 21/45; H04N 21/442; H04N 21/438; H04N 21/466; H04N 21/84

(52) U.S. Cl. CPC H04N 21/4882; H04N 21/4532; H04N 21/84; H04N 21/4383; H04N 21/4667; H04N 21/44222

(57) ABSTRACT

Various implementations described herein are directed to technologies for automatically providing reminders based on user viewing history information. User preference information is automatically determined over time from user-selected multimedia content information. Preferred multimedia content is identified based on the automatically detected user preference information. A determination is made as to whether a set top box is tuned to the identified preferred multimedia content. A user prompt is generated for display on a display device when the user is tuned to content other than the identified preferred multimedia content. The user prompt is configured to receive input regarding viewing options for the identified preferred multimedia content.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Set top box users typically manually set reminders for certain programming through an electronic program guide. Existing set top boxes do not presently allow for reminders other than those that have been manually set by the user. Thus, certain users may forget to tune to a favorite program if those users are presently watching another program or have temporarily been attracted to a program other than their favorite program. The present disclosure addresses the shortcomings of the prior art.

### SUMMARY

Described herein are implementations of various technologies of a method for automatically providing reminders based on user viewing history information. User preference information is automatically determined over time from user-selected multimedia content information. Preferred multimedia content is identified based on the automatically detected user preference information. A determination is made as to whether a set top box is tuned to the identified preferred multimedia content. A user prompt is generated for display on a display device when the user is tuned to content other than the identified preferred multimedia content. The user prompt is configured to receive input regarding viewing options for the identified preferred multimedia content.

User preference information may include metadata associated with the multimedia content. The metadata may be collected at a set top box or at a headend and provided to a set top box. The metadata may include content information. The content information may include cast information, program information, genre information and/or programming similar to the user-selected multimedia content.

The user preference information may include tuning data associated with the multimedia content, a specific time of day and/or a specific time.

The viewing options may include an option to continue watching content other than the preferred multimedia content. When the user decides to continue watching the other content, the viewing options may also include an option to continue or discontinue generating the user prompt.

The viewing options may include an option to switch to the identified preferred multimedia content. When the user decides to switch to the identified preferred multimedia content, the viewing options may also include an option to continue or discontinue generating the user prompt.

Also described herein are implementations of various technologies of a device for automatically providing reminders based on user viewing history information. The device includes a set top box. The set top box may be configured to: automatically determine user preference information over time from user-selected multimedia content; identify preferred multimedia content based on the automatically detected user preference information; determine whether the set top box is tuned to the identified preferred multimedia content; and generate a user prompt for display on a display device when the user is tuned to content other than the identified preferred multimedia content, the user prompt configured to receive input regarding viewing options for the identified content.

Further described herein are implementations of various technologies of a non-transitory computer-readable medium having stored thereon a plurality of computer-executable instructions which, when executed by a computer, cause the computer to: automatically determine user preference information over time from user-selected multimedia content; identify preferred multimedia content based on the automatically detected user preference information; determine whether the set top box is tuned to the identified preferred multimedia content; and generate a user prompt for display on a display device when the user is tuned to content other than the identified preferred multimedia content, the user prompt configured to receive input regarding viewing options for the identified content.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates an example network environment in accordance with implementations of various techniques described herein.

FIG. 2 illustrates an example set top box in accordance with implementations of various techniques described herein.

FIG. 3 illustrates a flow diagram of a method for automatically providing reminders based on user viewing history information in accordance with implementations of various techniques described herein.

FIG. 4 illustrates a flow diagram of a method for automatically providing reminders based on user viewing history information in accordance with implementations of various techniques described herein.

FIG. 5 illustrates a schematic diagram of a computing system in which the various technologies described herein may be incorporated and practiced.

### DETAILED DESCRIPTION

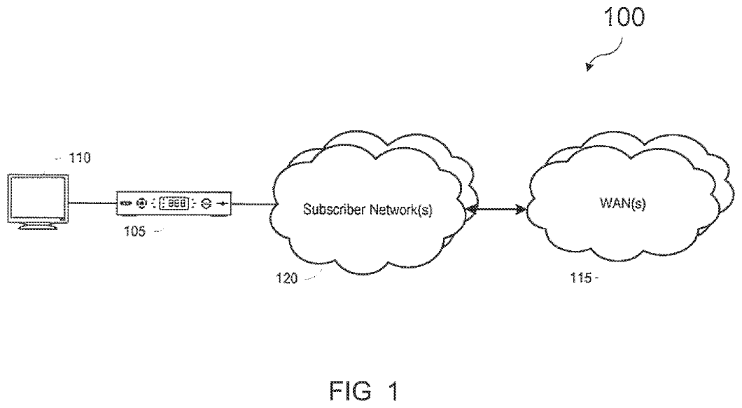

One or more implementations of various techniques for automatically providing reminders based on user viewing history information will now be described in more detail with reference to FIGS. 1-5 in the following paragraphs.

The present disclosure provides a way to remind a user to switch to a favorite TV program before the program begins on a particular channel. Techniques presented in the present disclosure provide a way to track/accumulate a user's viewing history during specific timeslots and automatically determine a user's preferences/habits. Users would be automatically reminded when their favorite programs are about to begin when they are watching another channel.

For example, consider the following example scenario. A program is scheduled to play every night at 8:00 pm on a particular channel. The user watches this program on Monday, Tuesday and Wednesday. On Thursday at 8:00 pm, the user is attracted to or already watching a movie on another channel. At some threshold time before 8:00 pm, a pop up window, e.g., a user prompt, is provided on the display to remind the user to switch to the channel that is playing the show that the user watched the previous three days.

Using the techniques of the present disclosure provide certain advantages. The set top box can automatically determine a user's preferences/habit without manually setting an appointment via an electronic program guide. The present disclosure records and analyzes the set top box play history and, based on the analysis, makes appointments automatically.

FIG. 1 is a block diagram illustrating an example network environment 100 for automatically providing reminders based on user viewing history information. In some implementations, video, voice, and/or data services may be delivered to one or more client devices via one or more customer premise equipment (CPE) devices installed within a subscriber premise. For example, multiple services may be provided by a set-top box (STB) 105 and may be received by a user through a display device (e.g., television 110). It should be understood that a user may receive multiple services through other display devices such as a mobile device, tablet, computer, gaming console, and others. The various data, multimedia, and/or voice services provided by the STB 105 may include, but is not limited to, live or broadcast television, video-on-demand (VoD) content, pay-per view content, recorded content (e.g., DVR content), audio-only content, streaming content, and others. A set-top box (STB) may receive content from multiple different networks and/or service providers and store this content in a memory. In one implementation, STB 105 may act as a digital media server in a DLNA-based network. In one implementation, STB 105 can be a digital video recorder (DVR) or any other multimedia device capable of providing DVR-like functionality.

Multiple services may be delivered to CPE devices over one or more local networks. For example, a local network may be provided by a gateway device, and the multiple services may be delivered to one or more CPE devices by the gateway device. Local network(s) may include a coaxial network, a local area network (LAN), wireless local area network (WLAN), personal area network (PAN), Multimedia over Coax Alliance (MoCA) network, mobile hotspot network, and others. It should be understood that the STB 105 may receive services from and may output upstream communications to an access point (e.g., gateway device, modem, router, wireless extender, etc.) over a wired or wireless connection to the access point.

Multiple services may be delivered to a subscriber premise from a wide-area network (WAN) 115 through a subscriber network 120. The subscriber network 120 may include, for example, a hybrid fiber-coaxial (HFC) network, fiber network, mobile network, satellite network, and any other network operable to deliver services to a subscriber premise.

Multimedia content may be received at the STB 105 as a content stream. For example, the content may be delivered to the STB 105 as a stream of packets or frames, and the packets or frames may be decoded and processed for presentation to a user through a connected display device (e.g., television 110).

The STB 105 may be configured to receive content from a plurality of content or service providers. For example, the STB 105 may receive content from a plurality of different subscriber networks 120 (e.g., a head end of a cable network, satellite network, etc.) and/or WANs 115. Content streams received from different service providers may be received at the STB 105 in different formats.

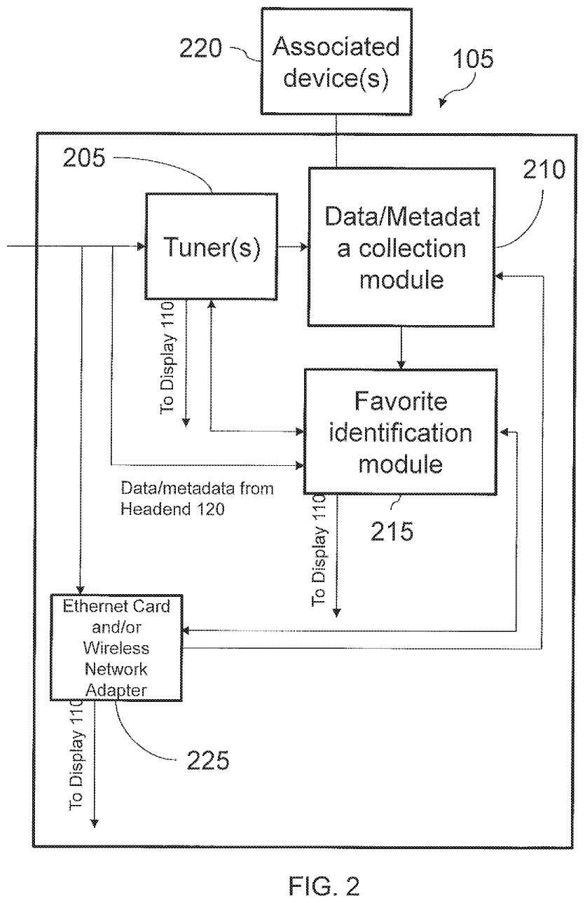

FIG. 2 is a block diagram illustrating an example set-top box (STB) 105 operable to automatically provide reminders based on user viewing history information in accordance with various implementations described herein. The STB 105 may include one or more tuner(s) 205, a data and/or metadata collection module 210, a favorite identification module 215, and an Ethernet card and/or wireless network adapter (EC/WNA) 225.

Multimedia content may be received at the tuner 205 or EC/WNA 225. For example, multimedia content may be received at the tuner 205 (or EC/WNA 225) from an upstream network (e.g., a head end in subscriber network 120 of FIG. 1) as a content stream (e.g., Internet protocol (IP) stream, MPEG stream, etc.). The tuner 205 (or EC/WNA 225) may decode the received content stream and process the content for output to a display device (e.g., television 110 of FIG. 1). It should be understood that content streams may be received at the tuner 205 (or EC/WNA 225) in a variety of formats and from a variety of content providers and/or networks. For example, the tuner 205 may receive content streams delivered to the STB 105 over a cable network and/or a satellite network. Also, EC/VVNA 225 may receive streaming data transferred through the internet and delivered to STB 105.

The data and/or metadata collection module 210 collects a watch history, e.g., information regarding user-selected multimedia content, over time. This watch history information may be collected from any associated device on which a user views content, e.g., set top box 105 and/or one or more associated devices 220 of a user. The associated device(s) may include a mobile device, a tablet, a computer, a gaming console, etc. In one implementation, data and/or metadata collection module 210 is included in the head end 120.

The favorite identification module 215 automatically determines user preference information over time. Favorite identification module 215 determines the user preference information from user-selected multimedia content information, e.g., watch history, received from the data and/or metadata collection module 210 or the head end 120. Favorite identification module 215 identifies preferred multimedia content based on the automatically detected user preference information.

Favorite identification module 215 includes a list that includes favorites of a user that occur in specific timeslots. Favorite identification module 215 determines whether STB 105 is already tuned to the channel showing the identified preferred multimedia content. Favorite identification module 215 presents certain options to the user depending on whether or not the user is tuned to the channel that includes the identified preferred multimedia content.

When the user is tuned to content other than the identified preferred multimedia content, a user prompt is generated for display on the display device. This user prompt is generated and displayed to the user at some threshold time before the identified preferred multimedia content is scheduled to begin. The user prompt is configured to receive input regarding viewing options for the identified preferred multimedia content.

The viewing options may include an option to continue watching content other than the preferred multimedia content. If the user decides to continue watching this other content, the user may also be presented with an option to either continue generating the user prompt or discontinue generating the user prompt.

The viewing options may include an option to switch to the identified preferred multimedia content. If the user decides to switch the channel, the channel is changed to the preferred multimedia content, e.g., using tuner 205. The user may also be presented with an option to either continue generating the user prompt or discontinue generating the user prompt.

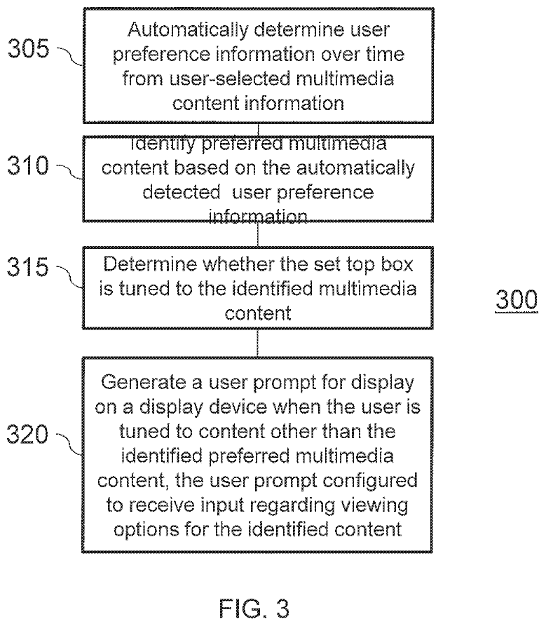

FIG. 3 illustrates a diagram of a method 300 for automatically providing reminders based on user viewing history information in accordance with implementations of various techniques described herein. At block 305 user preference information is automatically determined over time from user-selected multimedia content information.

At block 310, preferred multimedia content is identified based on the automatically detected user preference information.

The user preference information may include tuning data associated with the multimedia content, e.g., channel information. The user preference information may also include metadata or any other data associated with the multimedia content. In one implementation, the metadata is collected at a headend and provided to STB 105 at favorite identification module 215. In another implementation, the metadata is collected at STB 105 in data/metadata collection module 210 and provided to favorite identification module 215.

The metadata may include content information, e.g., any information related to the content. Examples of content information include program information, e.g., a title of a program and/or a description of a program. Examples of content information may also include cast information, genre information, and/or programming similar to the user-selected multimedia content.

User preference information may also include time data. The user may tune to a specific channel and/or program on a specific day and/or at a specific time. The favorite identification module

At block 315, a determination is made as to whether or not the STB 105 is tuned to the identified preferred multimedia content. Favorite identification module 215 includes a list that includes favorite programs of a user that occur in specific timeslots. When favorite identification module 215 determines from the list that preferred multimedia content is scheduled to be broadcast in the next time slot, the favorite identification module 215 first determines whether STB 105 is already tuned to the channel that includes the identified preferred multimedia content. Favorite identification module 215 presents certain options to the user depending on whether or not the user is tuned to the channel that includes the identified preferred multimedia content. When the user is already tuned to the channel that includes the preferred multimedia content, no further action is necessary.

At block 320, a user prompt is generated for display on a display device when the user is tuned to content other than the identified preferred multimedia content. The user prompt is configured to receive input regarding viewing options for the identified content.

The viewing options include an option to continue watching content other than the preferred multimedia content. If the user is watching another program on another channel, the user has the option to continue watching that program rather than tuning to the preferred multimedia content on a different channel.

The user may further choose to allow the favorite identification module 215 to continue or discontinue generating the user prompt for reminding the user about preferred multimedia content in the future.

The viewing options also include an option to switch to the preferred multimedia content. If the user is watching another program on another channel, the user can tune to the preferred multimedia content on the associated channel.

The user may further choose to allow the favorite identification module 215 to continue or discontinue generating the user prompt for reminding the user about preferred multimedia content in the future.

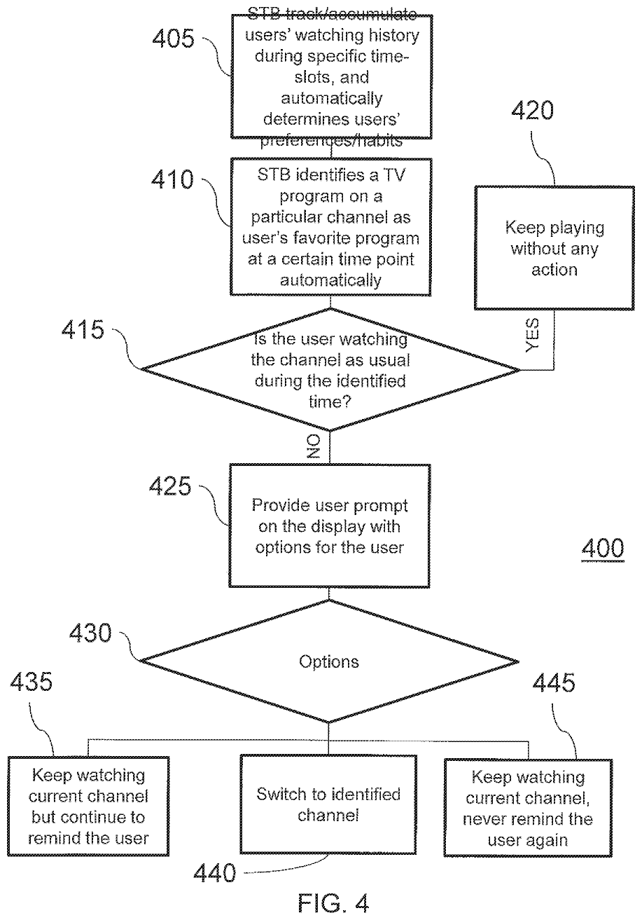

FIG. 4 illustrates a diagram of a method 400 for automatically providing reminders based on user viewing history information in accordance with various techniques described herein. At block 405, STB 105 tracks/accumulates a user's viewing history during specific timeslots. The accumulation of the user's viewing history can be accomplished, for example, by data/metadata collection module 210.

At block 410, the STB 105 automatically identifies a television program on a particular channel as a user's favorite program at a certain time point. The user's favorite program(s) may be identified based on user preference information. The user preference information may include tuning data associated with the multimedia content, e.g., channel information. The user preference information may also include metadata or any other data associated with the multimedia content. In one implementation, the metadata is collected at a headend and provided to STB 105 at favorite identification module 215. In another implementation, the metadata is collected at STB 105 in data/metadata collection module 210 and provided to favorite identification module 215.

At block 415, a determination is made as to whether the user is watching the favorite program and/or channel as usual during the intended time, e.g., time slot. If the user is viewing the favorite program already, the content on the present channel will continue playing without any further action, as shown at block 420.

If the user is not viewing the program, at block 425, a user prompt is provided on the display with further options for the user. At block 430, the user is provided with three options.

At block 435, the user is given the option to continue watching the current channel. The user can also choose to continue to receive reminders for the user's favorites.

At block 440, the user is given the option to switch to the identified channel. The user may also choose to continue to receive reminders for the user's favorites.

At block 445, the user is given the option to continue watching the current channel. With this option, the user can choose to discontinue reminders for that particular favorite program.

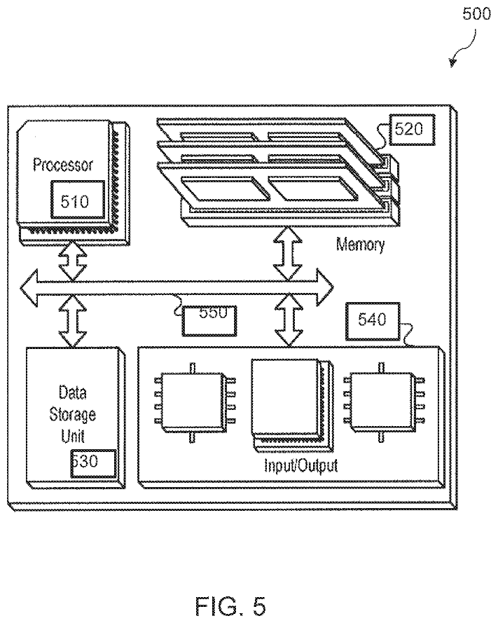

FIG. 5 is a block diagram of a hardware configuration 500 operable to automatically provide reminders based on user viewing history information. The hardware configuration 500 can include a processor 510, a memory 520, a storage device 530, and an input/output device 540. Each of the components 510, 520, 530, and 540 can, for example, be interconnected using a system bus 550. The processor 510 can be capable of processing instructions for execution within the hardware configuration 500. In one implementation, the processor 510 can be a single-threaded processor. In another implementation, the processor 510 can be a multi-threaded processor. The processor 510 can be capable of processing instructions stored in the memory 520 or on the storage device 530.

The memory 520 can store information within the hardware configuration 500. In one implementation, the memory 520 can be a computer-readable medium. In one implementation, the memory 520 can be a volatile memory unit. In another implementation, the memory 520 can be a non-volatile memory unit.

In some implementations, the storage device 530 can be capable of providing mass storage for the hardware configuration 500. In one implementation, the storage device 530 can be a computer-readable medium. In various different implementations, the storage device 530 can, for example, include a hard disk device/drive, an optical disk device, flash memory or some other large capacity storage device. In other implementations, the storage device 530 can be a device external to the hardware configuration 500.

The input/output device 540 provides input/output operations for the hardware configuration 500. In one implementation, the input/output device 540 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video, voice, and/or data services to a display device (e.g., television 110 of FIG. 1, mobile device, tablet, computer, etc.). In embodiments, the input/output device can include driver devices configured to send communications to, and receive communications from one or more networks (e.g., local network, subscriber network 120 of FIG. 1, WAN 115 of FIG. 1, etc.).

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
automatically determining user preference information over time from user-selected multimedia content information;
identifying preferred multimedia content based on the automatically detected user preference information;
determining whether a set top box is tuned to the identified preferred multimedia content; and
generating a user prompt for display on a display device when the user is tuned to content other than the identified preferred multimedia content, the user prompt configured to receive input regarding viewing options for the identified preferred multimedia content.

2. The method of claim 1, wherein user preference information comprises metadata associated with the multimedia content.

3. The method of claim 2, wherein the metadata is collected at a headend and provided to a set top box.

4. The method of claim 2, wherein the metadata is collected at a set top box.

5. The method of claim 2, metadata comprises content information.

6. The method of claim 5, wherein content information comprises cast information.

7. The method of claim 5, wherein content information comprises program information.

8. The method of claim 5, wherein content information comprises genre information.

9. The method of claim 5, wherein content information comprises programming similar to the user-selected multimedia content.

10. The method of claim 1, wherein the user preference information comprises tuning data associated with the multimedia content.

11. The method of claim 1, wherein the user preference information comprises a specific day.

12. The method of claim 1, wherein the user preference information comprises a specific time.

13. The method of claim 1, wherein the viewing options comprise an option to continue watching content other than the preferred multimedia content.

14. The method of claim 13, wherein the viewing options further comprise an option to continue generating the user prompt.

15. The method of claim 13, wherein the viewing options further comprise an option to discontinue generating the user prompt.

16. The method of claim 1, wherein the viewing options comprise an option to switch to the identified preferred multimedia content.

17. The method of claim 16, wherein the viewing options further comprise an option to continue generating the user prompt.

18. The method of claim 16, wherein the viewing options further comprise an option to discontinue generating the user prompt.

19. A device, comprising:
a set top box configured to:
automatically determine user preference information over time from user-selected multimedia content;
identify preferred multimedia content based on the automatically detected user preference information;
determine whether the set top box is tuned to the identified preferred multimedia content; and
generate a user prompt for display on a display device when the user is tuned to content other than the identified preferred multimedia content, the user prompt configured to receive input regarding viewing options for the identified preferred multimedia content.

20. A non-transitory computer-readable medium having stored thereon a plurality of computer-executable instructions which, when executed by a computer, cause the computer to:
automatically determine user preference information over time from user-selected multimedia content;
identify preferred multimedia content based on the automatically detected user preference information;
determine whether the set top box is tuned to the identified preferred multimedia content; and
generate a user prompt for display on a display device when the user is tuned to content other than the identified preferred multimedia content, the user prompt configured to receive input regarding viewing options for the identified preferred multimedia content.
